(19) United States
(12) Patent Application Publication
(10) Pub. No.: US 2011/0197751 A1
(43) Pub. Date: Aug. 18, 2011

(54) RECIPROCATING PISTON MACHINE

(75) Inventors: Jan Hinrichs, Friedrichsdorf (DE); Frank Sieber, Aalen (DE)

(73) Assignee: IXETIC MAC GmbH

(21) Appl. No.: 12/673,285

(22) PCT Filed: Jul. 25, 2008
(86) PCT No.: PCT/EP08/06158

§ 371 Date: Feb. 12, 2010

(30) Foreign Application Priority Data
Aug. 25, 2007 (DE) 10200704181.9

(51) Int. Cl. F16K 13/00

(52) U.S. Cl. 91/468

(57) ABSTRACT

A reciprocating piston machine is proposed, in particular, for motor vehicles, comprising
at least one piston movably supported within a cylinder bore, and comprising
a valve device (1) interacting with the at least one piston, the device having a valve carrier (3) and an intake valve (5) provided with a number of valve fingers (7).

The invention relates to a reciprocating piston machine as specified in the preamble of Claim 1.

Reciprocating piston machines of the type discussed here are well known. They are employed in particular to regulate the passenger cell temperature in motor vehicles. The reciprocating piston machines discussed here may relate to axial piston machines, but also to radial piston machines. Reciprocating piston machines of this type have at least one piston that is movable within a cylinder bore provided in a cylinder block. The reciprocating piston machines discussed here also have at least one valve device interacting with the at least one piston. The valve device comprises a valve carrier and an intake valve that has a number of valve fingers. The bottom of the intake valve and its valve fingers rest on a seating surface of the valve carriers. Each valve finger covers one intake bore that provides the flow of refrigerant from a suction chamber into the cylinder bore accommodating the piston. What is preferably provided as the refrigerant is, for example, CO₂ gas. In response to a movement of the piston within the cylinder bore away from the valve device, the suction force of the piston must overcome the adhesion force of the valve finger on the valve carrier such that the valve finger finally releases from the valve carrier and unblocks the intake bore. Some refrigerants require the diameter of the intake bore to be restricted, with the result that the pressure on the valve finger from the suction chamber side is diminished and a consequently greater adhesion force must be overcome. In the case of these reciprocating piston machines in particular, what has been found is that the suction force by the piston is often insufficient to overcome the adhesion force of the valve finger against the valve carrier, that is, so as to release the valve finger from the valve carrier and thus unblock the intake bore. As a result, the reciprocating piston machine has less desirable startup properties and reduced efficiency.

The problem to be solved by this invention is thus to create a reciprocating piston machine that does not have the above-referenced disadvantages.

What is proposed to solve this problem is a reciprocating piston machine having the features of Claim 1. It is characterized in that at least one depression is provided in the valve carrier and/or in the bottom side of the valve finger facing the valve carrier, which depression is disposed in certain areas between the valve finger and the valve carrier and which in certain areas communicates with the cylinder bore. The invention thus advantageously realizes a reduction in the support surface of the valve finger on the valve carrier, thereby reducing the adhesion force between the seating surface, the valve carrier, and valve finger. As a result of the at least one depression that communicates in certain areas with the cylinder bore and is disposed in certain areas between the valve carrier and valve finger, the bottom side of the of the valve finger is essentially ventilated, in other words has refrigerant flowing under it. As a result, reduced forces must be applied to overcome the adhesion force of the valve finger on the valve carrier and thus release the valve finger from the valve carrier, and thereby move the intake valve to the opened state. It is thus possible also to provide intake bores of relatively smaller diameter which enhance the adhesion force of the valve finger and thus necessitate a higher suction force in order to open the intake valve. Due to the depressions that on the one hand communicate with the cylinder bore and on the other hand are provided between the valve carrier and the valve finger, the valve finger no longer adheres so strongly to the valve carrier as a result of the reduced seating surface.

What is preferred in particular is a reciprocating piston machine that is characterized in that the at least one depression is provided in the region of a valve finger arm in the valve carrier and/or in the bottom side of the valve finger facing the valve carrier. This measure achieves an especially effective reduction in the adhesion force, and thus a reduction in the suction force to be exerted on the intake valve.

What is furthermore preferred is a reciprocating piston machine that is characterized in that the at least one depression has the shape of an elongated groove. This shape provides an especially effective ventilation of the bottom side of the valve finger and/or valve arm, thereby reducing the adhesion force to be overcome of the valve finger on the valve carrier.

What is also preferred is a reciprocating piston machine that is characterized in that the at least one depression is of circular shape. This aspect too results in a reduction in the adhesion force of the valve finger and/or valve am on the valve carrier. In principle, any desired design is conceivable for the at least one depression so that this invention is not restricted to the exemplary embodiments described here.

What is furthermore preferred is a reciprocating piston machine that is characterized in that the at least one depression is disposed in the bottom side of the valve finger facing the valve carrier and extends over the entire width of the valve finger arm. As a result, a very effective reduction of the support surface is achieved, which reduction results in an effective reduction in the adhesion force of the valve finger on the valve carrier.

What is furthermore preferred is a reciprocating piston machine that is characterized in that the at least one depression is provided in the valve carrier, and this depression extends over the entire width of the valve finger arm and extends beyond the two lateral edges of the valve finger arm. This design provides an especially effective flow below the bottom side of the valve finger arm and a reduction in the support surface, thereby significantly reducing the adhesion force.

Finally, a reciprocating piston machine is preferred that is characterized in that multiple depressions are provided. Multiple depressions further reduce the support surface so as to allow ventilation to occur at multiple sites along the bottom side of the valve finger, and additionally so that the support surface of the valve finger is significantly reduced.

The following discussion describes the invention in more detail based on the drawing. Here:

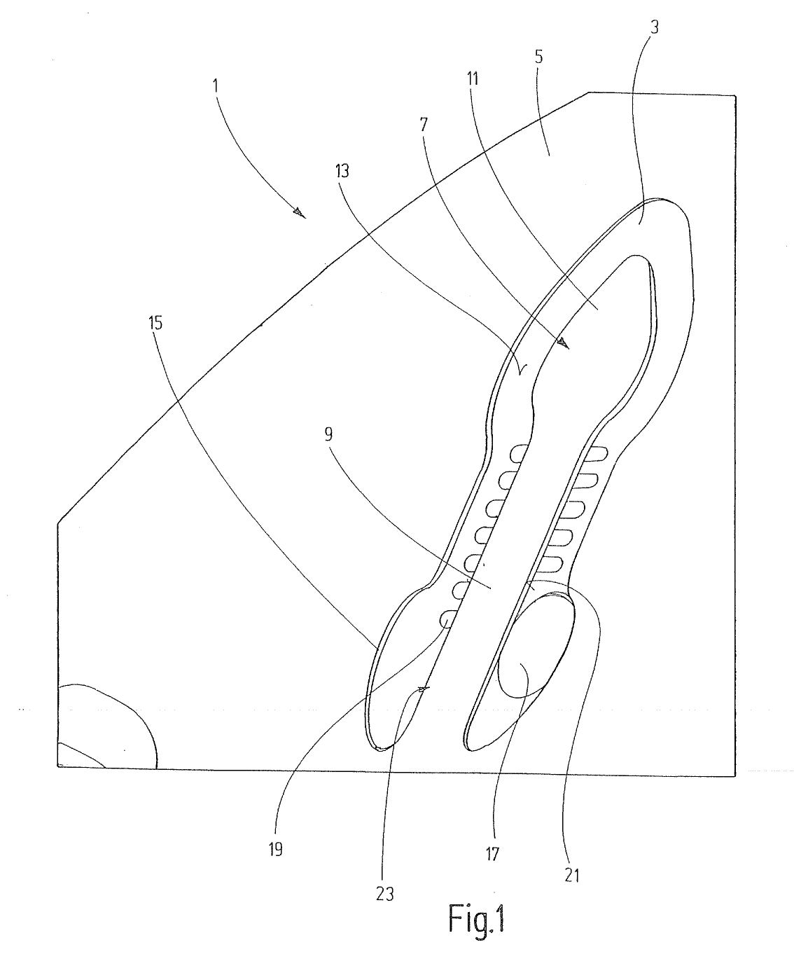

FIG. 1 is a perspective view showing one region of a valve device; and

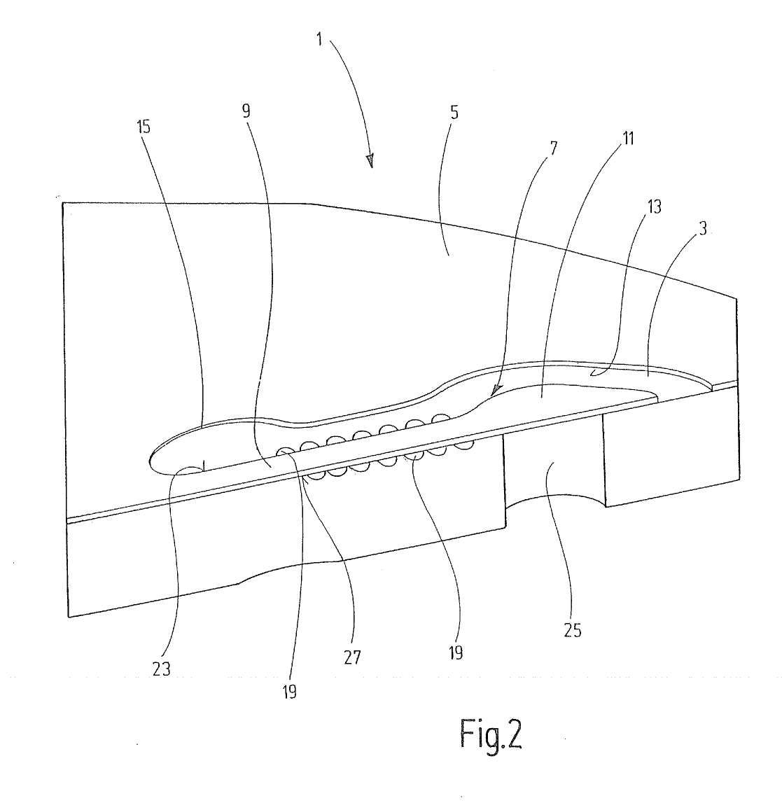

FIG. 2 illustrates a section through the valve device of FIG. 1.

FIG. 1 is a perspective view showing one region of a valve device 1. Valve device 1 has a valve carrier 3 and a plate-like intake valve 5. Valve device 1 interacts with a piston, not shown here, that is movably supported within cylinder bore. In response to movement of the piston within the cylinder bore away from the valve device, suction forces are created that must overcome the adhesion force of at least one valve finger 7 against valve carrier 3 in order to release valve finger 7 from valve carrier 3 and unblock an intake bore, not shown here. Due to production process requirements, which preferably comprises a stamping process, the at least one valve finger 7 is of a one-piece design integrated with intake valve 5.

Intake valve 5 preferably has a number of valve fingers 7, one each of which is associated with an intake bore. A piston supported within a cylinder bore is also associated with each valve finger 7.

Valve finger 7 comprises a valve finger arm 9 and a valve finger head 11. Valve finger head 11 covers the intake bore, not shown here, which with the intake valve in the opened state, that is, whenever valve finger head 11 is not covering the intake bore, ensures a fluid communication between a suction region and the cylinder bore. Intake valve 5 and its number of valve fingers 7, only one of which is shown here, rests on a seating surface 13 of valve carrier 3. In order to ensure that valve finger 7 can freely move independently of the rest of intake valve 5, a recess 15 is provided within intake valve 5 around valve finger 7. In addition, an outlet bore 17 is disposed in the region of recess 15, the outlet bore creating a fluid communication between the cylinder bore and a pressure chamber separated from the suction region.

A pressure valve, not shown here, which also has valve fingers that close outlet bore 17, is disposed on the surface of valve carrier 3 opposite seating surface 13. Whenever the piston within the cylinder bore moves towards valve system 1, the pressure valve not shown here is forced away from the surface of valve carrier 3 opposite seating surface 13 by the pressure of the compressed refrigerant, thereby enabling the refrigerant to flow between the cylinder bore and the pressure chamber.

As was already explained above, in order to open intake valve 5, that is, to lift valve finger 7 from the not-shown intake bore under valve finger head 11, adhesion forces must be overcome that exist between valve finger 7 and seating surface 13 of valve carrier 3. The adhesion force between valve finger 7 and seating surface 13 is proportionately greater, as the support surface of valve finger 7 on valve carrier 3 becomes greater. What is understood by the term support surface here is the sum of the regions in which valve finger 7 and valve carrier 3 are in contact. For certain refrigerants, in particular, gaseous ones, it is necessary to provide the intake bore with a smaller diameter. As a result, the force acting on the bottom side of valve finger 7, which side is not visible here, is reduced by the refrigerant present in the suction chamber. In commensurate fashion, the adhesion force increases between valve finger 7 and seating surface 13, which force must be overcome by the suction force of the piston.

In order to improve startup properties, the present invention has at least one depression 19 in the valve carrier 3 and/or in the bottom side, not visible here, of valve finger 7 facing valve carrier 3, which depression is disposed in certain areas between valve finger 7 and valve carrier 3 and communicates in certain areas with the cylinder bore that is not visible here. In the embodiment shown in FIG. 1, multiple depressions 19 are provided in valve carrier 3 which in extremely effective fashion reduce the support surface of valve finger 7 on seating surface 13. Depressions 19 are preferably provided in the region of valve finger arm 9. However, another conceivable approach is to dispose depressions 19 in the region of valve finger head 11. What is critical here is that depressions 19 not communicate with the intake bore, not visible here, since otherwise a short circuit would result between the suction chamber and the cylinder bore.

Depression 19 is implemented here in the form of an elongated groove that extends within valve carrier 3 over the entire width of valve finger arm 9 and extends beyond the arm's lateral edges 21 and 23. Depression 19 provided in valve carrier 3 thus communicates on one side with the cylinder bore adjoining valve device 1 and on the other side is disposed between valve finger 7 and valve carrier 3, or is covered by valve finger 7. As a result, refrigerant is able to move more easily through depressions 19 from the suction chamber, which refrigerant essentially flows under the bottom side of valve finger 7, that is, the side of valve finger 7 resting on seating surface 13. Thus relatively lower adhesion forces present between valve finger 7 and valve carrier 3 must be overcome—on the one hand, due to the under-flow and, on the other hand, due to the relatively smaller support surface of valve finger 7 on seating surface 13 of valve carrier 3. As a result, the startup behavior and efficiency of the reciprocating piston machine is significantly improved.

Provision can also be made whereby the at least one depression 19 is of circular shape. What is also critical here is that one region of depression 19 be covered by valve finger 7 or by valve carrier 3 and communicate on the other side with the cylinder bore.

In the event depressions have not been incorporated in valve carrier 3 but into the bottom side of valve finger 7 facing valve carrier 3, which side is not visible here, depression 19 must in any case extend up to the lateral edges 21 and/or 23 so that depression 19 incorporated into the bottom side of valve finger 7 remains in communication with the cylinder bore. Here too, depression 19 can have a variety of shapes. One conceivable approach in particular is to provide at least one depression 19 in the bottom side of valve finger 7, which depression extends over the entire width of valve finger arm 9, that is, from one lateral edge 21 up to the other lateral edge 23. As a result, the support surface of valve finger 7 on seating surface 13 is reduced very effectively.

FIG. 2 illustrates a section through valve device 1 of FIG. 1. Identical parts are provided with identical reference numbers so as to avoid repetitions whenever reference is made to the description relating to FIG. 1.

Seen in FIG. 2 is intake bore 25 that is covered by valve finger head 11 of the valve finger and to which a suction chamber connects on the opposite side of intake valve 5, from which chamber refrigerant to be compressed is intended to flow through intake bore 25 into the cylinder bore. FIG. 2 once again highlights the fact that the at least one depression 19 on the one hand communicates with the cylinder bore and on the other hand is covered in particular by valve finger arm 9 of valve finger 7. In the event that depressions 19 are located in bottom side 27 of valve finger 7, depression 19 is covered by valve carrier 3.

As was already explained above, provision can also be made whereby depressions 19 are provided in the region of valve finger head 11, which depressions in turn are incorporated in valve carrier 3 and/or into the bottom side 27 of valve finger 7. In each case, care must be taken to ensure that depressions 19 are not in fluid communication with intake bore 25 since this would result in a short circuit between the suction region and the cylinder bore.

The present invention advantageously provides a reduction in the support surface between valve finger 7 and valve carrier 3, thereby significantly reducing the adhesion force between these two elements. Due to the fact that depressions 19 on the one hand communicate with the cylinder bore and on the other hand are disposed between valve carrier 3 and valve finger 7, valve finger 7 is essentially ventilated from its bottom side 27, which process in turn significantly reduces the adhesion forces between valve finger 7 and valve carrier 3. The forces acting on intake valve 5, or more precisely, on valve finger 7 can thus be significantly better defined. In addition, the startup behavior and efficiency of the reciprocating piston machine are significantly improved. Furthermore, the invention presented here achieves a reduction in noises caused by the movements of valve finger 7.

It goes without saying that the present invention can be employed analogously with axial piston machines and with radial piston machines.

### LIST OF REFERENCE NUMBERS

1 valve device
3 valve carrier
5 intake valve
7 valve finger
9 valve finger arm
11 valve finger head
13 seating surface
15 recess
17 outlet bore
19 depression
21 side wall
23 side wall
25 intake bore
27 bottom side

1-7. (canceled)

8. A reciprocating piston machine for motor vehicles comprising:
at least one piston movably supported within a cylinder bore; and
a valve device interacting with the at least one piston, the valve device having a valve carrier and an intake valve provided with a number of valve fingers; and
at least one depression provided in the valve carrier and/or in a bottom side of the valve finger facing the valve carrier, the depression being disposed between the valve finger and the valve carrier and communicating with the cylinder bore.

9. The reciprocating piston machine according to claim 8, wherein the at least one depression is provided in a region of a valve finger arm in the valve carrier and/or in the bottom side of the valve finger facing the valve carrier.

10. The reciprocating piston machine according to claim 8, wherein the at least one depression is in the shape of an elongated groove.

11. The reciprocating piston machine according to claim 8, wherein the at least one depression is of circular shape.

12. The reciprocating piston machine according to claim 8, wherein the at least one depression in the bottom side of the valve finger facing the valve carrier extends over an entire width of the valve finger arm.

13. The reciprocating piston machine according to claim 8, wherein the at least one depression is provided in the valve carrier and extends over an entire width of the valve finger arm and beyond two lateral edges of the valve finger arm.

14. The reciprocating piston machine according to claim 8, wherein the at least one depression includes a plurality of depressions.
